(19) United States
(12) Patent Application Publication
(10) Pub. No.: US 2025/0355608 A1
(43) Pub. Date: Nov. 20, 2025

(54) IMAGE PROCESSING DEVICE, IMAGE PROCESSING METHOD, AND RECORDING MEDIUM

(71) Applicant: CANON KABUSHIKI KAISHA, Tokyo (JP)

(72) Inventor: Keita KATO, Tokyo (JP)

(21) Appl. No.: 19/185,673

(22) Filed: Apr. 22, 2025

(30) Foreign Application Priority Data
May 14, 2024 (JP) 2024-078896

(51) Int. Cl. G06F 3/14

(52) U.S. Cl. CPC G06F 3/14

(57) ABSTRACT

An image processing device includes calculation means for acquiring information including a defocus range of a captured image from storage means in which information including the defocus range of the captured image is stored as incidental information of the captured image, and calculating a focal ratio of the captured image based on the information including the defocus range, and display control means for performing display control of the captured image based on the focal ratio.

### BACKGROUND

### Field

The present invention relates to image display processing.

### Description of the Related Art

When checking captured images after imaging with a camera, a user may select the captured images while checking each image to see if it is focused at the position desired by the user. In this case, in a case of checking a large number of captured images, a lot of time and effort may be required to select the captured images that are in focus at the desired position.

In order to solve such problems, in JP 2012-15742 A, a method has been proposed for selecting captured images in which a face area is in focus by acquiring the face area and the focal position from the captured images and displaying captured images in which the areas are determined to match.

However, in the conventional technology disclosed in the above-mentioned JP 2012-15742 A, since the captured image is selected based only on the face area and the focal position, there was a problem in that it was difficult to select a captured image that was accurately focused on the position desired by the user.

The present disclosure provides an image processing device that assists the user in selecting captured images.

### SUMMARY

An image processing device as an aspect of the present invention includes calculation means for acquiring information including a defocus range of a captured image from storage means in which information including the defocus range of the captured image is stored as incidental information of the captured image, and calculating a focal ratio of the captured image based on the information including the defocus range, and display control means for performing display control of the captured image based on the focal ratio.

Further features of the present invention will become apparent from the following description of exemplary embodiments with reference to the attached drawings.

### BRIEF DESCRIPTION OF THE DRAWINGS

FIG. 1 is a hardware configuration diagram of an image processing device according to an embodiment.

FIG. 2 is a schematic diagram illustrating a relationship between a defocus amount and an image shift amount according to the embodiment.

FIGS. 3A and 3B are schematic explanatory diagrams of a defocus range according to the embodiment.

FIG. 4 is a block diagram illustrating a configuration example of an image processing device according to Embodiment 1.

FIG. 5 is a flowchart illustrating processing of the image processing device according to Embodiment 1.

FIGS. 6A and 6B are diagrams illustrating an example of a result of estimating a defocus range of the entire subject in a captured image according to Embodiment 1.

FIG. 7 is a diagram illustrating a configuration example of a captured image in which captured image defocus range information according to Embodiment 1 is stored as incidental information.

FIG. 8 is a diagram of an example of a display in which captured images and the focal ratios are associated with each other based on a display order according to Embodiment 1.

FIG. 9 is a block diagram illustrating a configuration example of an image processing device according to Embodiment 2.

FIG. 10 is a flowchart illustrating processing of the image processing device according to Embodiment 2.

FIG. 11 is a diagram illustrating a configuration example of a captured image in which defocus range information during AF control and a lens drive amount are stored as incidental information according to Embodiment 2.

FIG. 12 is a diagram illustrating a method of calculating captured image defocus range information according to Embodiment 2.

FIG. 13 is a diagram illustrating an example of a display in which a captured image and a focal ratio are associated with each other based on a partial area image according to Embodiment 2.

### DESCRIPTION OF THE EMBODIMENTS

Hereinafter, preferred embodiments of the present invention will be described in detail with reference to the accompanying drawings. The configuration shown in the following embodiments is only an example, and the present invention is not limited to the configuration shown in the figure.

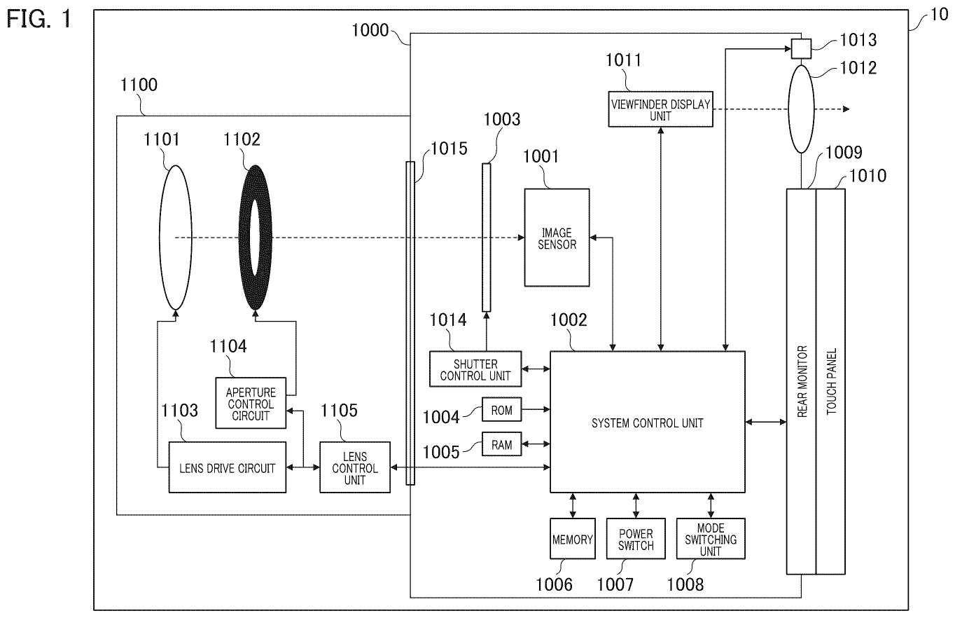

Hereinafter, before describing the embodiments of the present invention, the hardware configuration in which each of the embodiments described below is implemented is described using FIG. 1. FIG. 1 is a diagram illustrating a hardware configuration of an image processing device 10 in each embodiment. That is, the image processing devices 10 of Embodiment 1 and Embodiment 2 have the same configuration.

The image processing device 10 is an image processing device equipped with an imaging function, for example, an imaging apparatus (imaging device). The image processing device 10 is composed of a camera main body 1000 and a lens unit 1100 that directs incident light to an image sensor 1001. The camera main body 1000 is described first below.

The image sensor 1001 is composed of a CMOS type imaging sensor and converts optical signals, which are optical images, into electrical signals. The light rays incident on an imaging lens 1101 form an optical image on the image sensor 1001 through an aperture 1102 and a shutter 1003.

A system control unit 1002 is composed of at least one computer with a built-in CPU or the like, and controls the entire camera main body 1000. The system control unit 1002 further includes an image processing unit (not illustrated) for the video signals obtained by the image sensor 1001. It further includes a phase detection AF unit (not illustrated) that performs focus detection processing using the phase detection method based on image data for focus detection (signals for phase detection AF) obtained from the image sensor 1001 and image processing unit. More specifically, the image processing unit generates a pair of pieces of image data formed by light fluxes passing through a pair of pupil areas of the imaging optical system as image data for focus detection. The phase detection AF unit detects the amount of out-of-focus based on the amount of misalignment of a pair of image data. Thus, the phase detection AF unit does not use a dedicated AF sensor, but performs phase detection AF (image plane phase detection AF) based on the output of the image sensor 1001. The system control unit 1002 may be configured and function as an image processing device. In such a case, the camera main body 1000 of an imaging apparatus (imaging device) with an imaging function can incorporate an image processing device.

A ROM 1004 is a nonvolatile memory that records programs that control the operation of the camera main body 1000 and learned machine learning models. A RAM 1005 is a volatile memory that records variables necessary for operations of the camera main body 1000, various parameters and set values such as ISO sensitivity, preset threshold values for image selection, live view images acquired during AF control, imaging modes, and various correction data.

A memory 1006 is a removable flash memory, which is a recording medium for recording images (captured images) and incidental information associated with the captured images. A power switch 1007 switches the power of the camera main body 1000 between on and off modes. A mode switching unit 1008 is a switch for switching and setting various imaging modes, such as live-view imaging and movie imaging.

A rear monitor 1009 is a display unit consisting of a liquid crystal device, LEDs, or the like that displays the operating status, such as text, captured images, and sound, and shooting information, such as messages, according to the execution of programs in the system control unit 1002. A touch panel 1010 is disposed in an area roughly equivalent to the rear monitor 1009, detects finger or pen contact, notifies the system control unit 1002 of the contact position relative to the rear monitor 1009, and performs operations or functions associated with the contact position.

A viewfinder display unit 1011, like the rear monitor 1009, is a display unit that displays shooting information according to the execution of programs in the system control unit 1002, and together with an ocular lens 1012, it constitutes an electronic viewfinder (EVF). An eye proximity detection unit 1013 selectively displays the aforementioned imaging information on the rear monitor 1009 or the viewfinder display unit 1011 by the system control unit 1002 according to the eyepiece status of the photographer. A shutter control unit 1014 controls the operation of the shutter 1003 based on the photometric results of the subject calculated by the system control unit 1002. The shutter 1003 can be controlled in conjunction with the aperture 1102.

Next, the configuration of the lens unit 1100 will be described. The camera main body 1000 and the lens unit 1100 are mechanically and electrically connected via the lens mount mechanism (mount portion) 1015. Furthermore, the camera main body 1000 and the lens unit 1100 are detachable via the lens mount mechanism 1015. The lens unit 1100 is configured of the imaging lens 1101, the aperture 1102, a lens drive circuit 1103, an aperture control circuit 1104, and a lens control unit 1105. For the sake of simplicity, only one imaging lens 1101 is illustrated in FIG. 1, but in reality, the imaging lens is made up of a number of imaging lens groups.

The lens control unit 1105 is configured with at least one computer having a CPU, memory, or the like, and controls the entire lens unit 1100. The memory (not illustrated) in the lens control unit 1105 stores, for example, various constants, variables and programs for lens operation. It also has a nonvolatile memory (not illustrated) that holds information specific to the lens unit, such as maximum and minimum aperture values and focal lengths.

The system control unit 1002 of the camera main body 1000 calculates the defocus amount using the output information of the image sensor 1001. Based on the calculated defocus amount, the system control unit 1002 communicates via the lens control unit 1105 of the lens unit 1100 and controls the lens drive circuit 1103 to focus the lens.

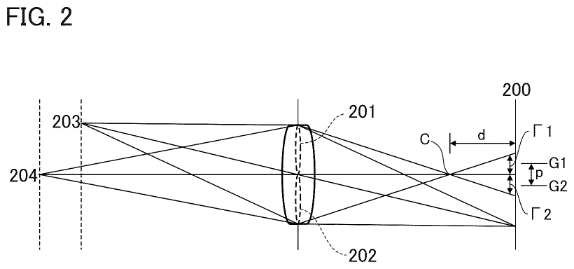

The defocus amount described above will be described in detail with reference to FIG. 2. FIG. 2 is a diagram illustrating a relationship between the defocus amount of the imaging optical system and the phase difference (image shift amount) between the first focus detection signal and the second focus detection signal acquired from the image sensor in the present embodiment.

The imaging sensor (not illustrated) is disposed on an imaging plane 200 in FIG. 2, and the exit pupil of the image processing device is divided into two parts: a first pupil area 201 and a second pupil area 202. A defocus amount d is defined as the distance (magnitude) from an image formation position C of the light flux from a subject 203 and a subject 204 to the imaging plane 200 as |d|, with the front focus state where the image formation position C is on the subject side from the imaging plane 200 expressed with a negative sign (d<0). It is further defined as the back focus state where the image formation position C is on the opposite side to the subject from the imaging plane 200, denoted by a positive sign (d>0). In the focal state, where the image formation position C is on the imaging plane 200, d=0. The imaging optical system is in a focal state (d=0) with respect to the subject 203 and in the front focus state (d<0) with respect to the subject 204. The front focus state (d<0) and the back focus state (d>0) together are called the defocused state (|d|>0).

In the front focus state (d<0), the light flux from the subject 204 that passes through the first pupil area 201 (second pupil area 202) is temporarily focused and then spreads out to a width Γ1 (Γ2) centered on the center of gravity position G1 (G2) of the light flux, forming a blurred image on the imaging plane 200. This blurred image is received by each first focus detection pixel (each second focus detection pixel) on the image sensor, and the first focus detection signal (second focus detection signal) is generated. In other words, the first focus detection signal (second focus detection signal) is a signal representing a subject image in which the subject 204 is blurred by a width I′1 (Γ2) at the center of gravity position G1 (G2) of the light flux on the imaging plane 200.

The width Γ1 (Γ2), which is the blur width of the subject image, increases roughly in proportion to the increase in the magnitude of the defocus amount d, |d|. Similarly, the magnitude of an image shift amount p (=difference in the position of the center of gravity of the light flux, G1−G2) between the first and second focus detection signals, |p|, also increases roughly in proportion to the increase in the magnitude of the defocus amount d, |d|. In the back focus state (d>0), the image shift direction between the first focus detection signal and the second focus detection signal is opposite to that in the front focus state, but the same is true.

Thus, the magnitude of the image shift amount between the first and second focus detection signals increases as the magnitude of the defocus amount increases. In the present embodiment, the imaging plane phase detection method focus detection is used to calculate the defocus amount from the amount of image shift between the first and second focus detection signals obtained using the image sensor 1001. Therefore, the phase detection AF unit of the system control unit 1002 converts the image shift amount to the detection defocus amount when the magnitude of the defocus amount of the imaging signal increases. Specifically, the image shift amount is converted to the detected defocus amount by a conversion factor calculated based on the baseline length from the relationship of increasing magnitude of the image shift amount between the first and second focus detection signals. The product of the aperture F value in the optical system of the imaging device at the time of image capture and the allowable circle of confusion diameter δ[Fδ] is used as the unit of the defocus amount in the present embodiment.

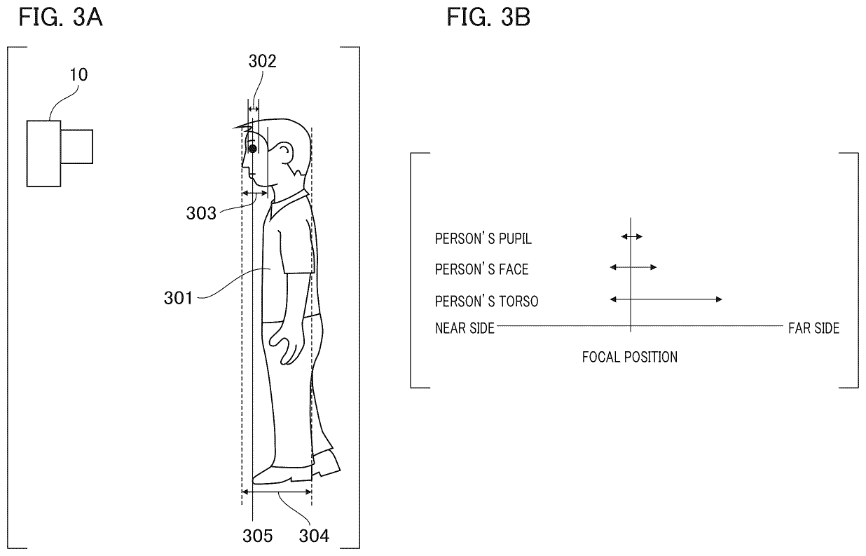

In addition, the defocus range, which will be described later, will be described in detail with reference to FIG. 3. FIG. 3 is a diagram illustrating the defocus range in the present embodiment. FIG. 3A illustrates how a person 301 is photographed using the image processing device 10.

In FIG. 3, reference numeral 302 denotes a person's pupil, 303 denotes a person's face, and 304 denotes a person's torso, which are visualized and displayed as their extent as objects in the depth direction as viewed from the image processing device 10. In addition, reference numeral 305 indicates that the focal position in the image processing device 10 is the position of the person's pupil 302.

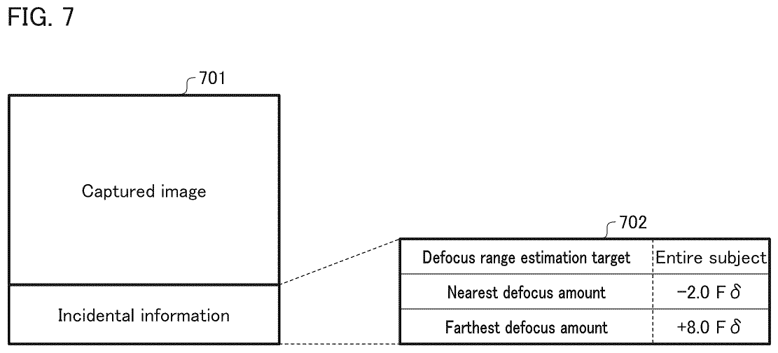

In addition, FIG. 3B is a schematic diagram illustrating the defocus ranges of the person's pupils 302, the person's face 303, and the person's torso 304. The horizontal axis direction indicates the amount of defocus, which is the degree to which the image is deviated from the focal position, based on the focal position that is the focal plane. That is, the magnitude (absolute value) of the defocus amount increases as the distance from the focal position increases. In the present embodiment, the horizontal axis direction is defined as the near side near the image processing device 10 and the far side far away, with the near side taking a negative (minus) value as the defocus amount and the far side taking a positive (plus) value as the defocus amount. The line segments indicate the range in which the respective parts of the subject (in FIG. 3B, these are the person's pupil, person's face, and person's torso) exist, and the distribution of the defocus amount values for the subject area corresponding to that range. This range is hereinafter referred to as the defocus range. The parameters of the defocus range are the values of the defocus amounts at the two end points of the range (the nearest and farthest defocus amounts illustrated in FIG. 7). For example, the defocus range of each area is indicated, such as a person's pupil (−0.05 to 0.10 [Fδ]), a person's face (−0.20 to 0.30 [Fδ]), a person's torso (−0.20 to 0.80 [Fδ]), and so on.

In FIG. 3A, for example, the spread of the person's torso 304 as an object relative to the depth direction viewed from the image processing device (imaging device) 10 is that the most proximal side is, for example, the tip of the person's nose and the most distant side is, for example, the tip of the person's shoulders. Therefore, the maximum value of the defocus amount (the nearest value) of the person's torso 304 is the defocus amount indicating the tip of the person's nose, and the minimum defocus amount (the farthest value) is the defocus amount indicating the tip of the person's shoulders. The value range defined by these values is the defocus range of the person's torso 304. The torso of the person in FIG. 3B represents these relationships, and the person's pupil and the person's face are also represented based on the above relationships. Although the defocus range of person's pupils, face, and torso has been described as an example here, there are no restrictions on the subject or body area that can be targeted, and the present embodiment is not limited to this case.

### Embodiment 1

The image processing device 10 of Embodiment 1 calculates the focal ratio based on the defocus range information for the entire subject stored as incidental information in the captured image. Then, the selection of captured images and the display order are determined based on the calculated focal ratio, and the captured images are displayed in association with the focal ratio, thereby supporting the task of selecting captured images.

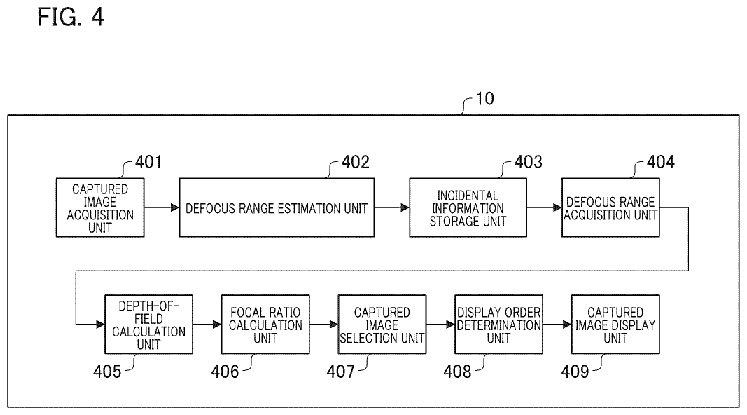

FIG. 4 is a block diagram illustrating a configuration example of the image processing device 10 according to Embodiment 1. The image processing device 10 includes a captured image acquisition unit 401, a defocus range estimation unit 402, an incidental information storage unit 403, and a defocus range acquisition unit 404. Furthermore, the image processing device 10 includes a depth-of-field calculation unit 405, a focal ratio calculation unit 406, a captured image selection unit 407, a display order determination unit 408, and a captured image display unit 409. FIG. 4 is an example of a functional configuration example and does not limit the scope of application of the present invention.

The captured image acquisition unit 401 acquires the captured images captured by the imaging device (image processing device 10) and recorded in the memory 1006. The captured image acquisition unit 401 then outputs the acquired captured image to the defocus range estimation unit 402.

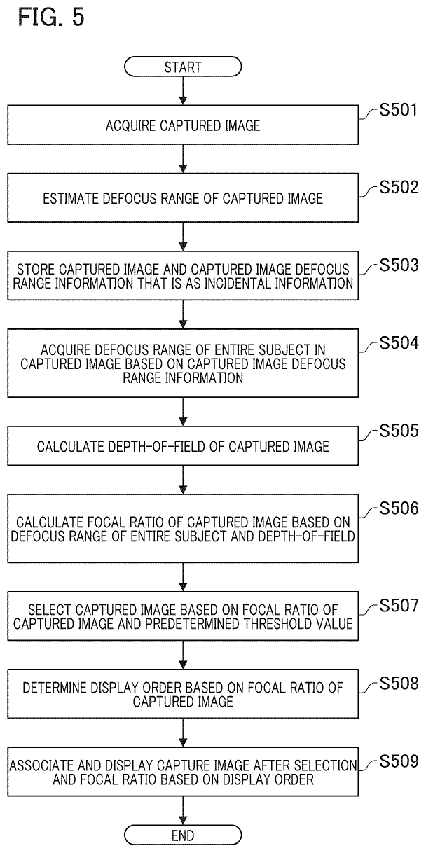

The defocus range estimation unit 402 estimates the defocus range of the entire subject in the received captured image. The details of the captured image defocus range estimation by the defocus range estimation unit 402 will be described using the flowchart in FIG. 5 below. The defocus range estimation unit 402 acquires the estimated result, the captured image defocus range information (first range information), and outputs the captured image defocus range information to the incidental information storage unit 403.

The incidental information storage unit 403 stores the received captured image defocus range information as incidental information for the captured image recorded in the memory 1006. The details of the processing of saving as incidental information of the captured image by the incidental information storage unit 403 will be described using the flowchart in FIG. 5 below. The incidental information storage unit 403 outputs the captured image defocus range information saved as incidental information of the captured image to the defocus range acquisition unit 404.

The defocus range acquisition unit 404 acquires the defocus range of the captured image based on the received captured image defocus range information. The defocus range acquisition unit 404 then outputs the acquired defocus range to the depth-of-field calculation unit 405.

The depth-of-field calculation unit 405 calculates the depth-of-field of the captured image recorded in memory 1006 that is tied to the received defocus range. Details of the depth-of-field calculation by the depth-of-field calculation unit 405 will be described using the flowchart in FIG. 5 below. The depth-of-field calculation unit 405 outputs the defocus range and calculated depth-of-field to the focal ratio calculation unit 406.

The focal ratio calculation unit 406 calculates the focal ratio based on the received defocus range and depth-of-field. The details of the focal ratio calculation by the focal ratio calculation unit 406 will be described using the flowchart in FIG. 5 below. The focal ratio calculation unit 406 stores the calculated focal ratio in the incidental information of the captured image recorded in the memory 1006 that is associated with the defocus range.

The captured image selection unit 407 acquires one or more captured images recorded in the memory 1006 and selects a captured image based on the focal ratio stored in the incidental information of the captured image. Specifically, the captured image selection unit 407 selects the captured images whose focal ratio is equal to or greater than a predetermined (default) threshold value. The captured image selection unit 407 outputs information on the display order of one or more captured images after selection to the display order determination unit 408.

The display order determination unit 408 determines the display order of the received one or more post-selection captured images to be displayed on the rear monitor 1009 or other imaging means based on the focal ratio stored in the incidental information of the captured images. The display order determination unit 408 outputs one or more captured images after selection and the display order to the captured image display unit 409.

The captured image display unit 409 displays the captured images on the rear monitor 1009 based on the received one or more post-selection captured images and the display order. When the captured image display unit 409 displays the captured image on the rear monitor 1009, the captured image display unit 409 displays the captured image on the rear monitor 1009 in association with the focal ratio. In addition, when the captured image display unit 409 displays the captured image on the rear monitor 1009 as described above, it is preferable to associate with the focal ratio to the captured image and display it, but it is also possible to display only the captured image without associating the focal ratio to the captured image. That is, only the captured images may be displayed based on the display order.

In addition, the captured image display unit 409 may also display the captured image and the focal ratio on an external monitor, display, or other display device. The display device may be integrated with a client device (information processing device) such as a PC, for example, or it may be a separate unit. In addition, the captured image display unit 109 may perform display on multiple display means, such as the external device or the rear monitor 1009.

Next, a processing procedure performed by the image processing device 10 in the present embodiment will be described with reference to FIG. 5. FIG. 5 is a flowchart illustrating the processing of the image processing device 10 according to Embodiment 1. Specifically, the flowchart illustrates the processing procedure for calculating the focal ratio of the entire subject based on the defocus range information stored in the incidental information of the captured image and displaying the captured image through image selection and display order determination.

Each operation (processing) illustrated in the flowchart of FIG. 5 is realized by the system control unit 1002 executing a program stored in the ROM 1004 or the like. In addition, in the following description, each process (step) is indicated by adding S at the beginning of the process (step) and the notation of the process (step) will be omitted.

In S501, the captured image acquisition unit 401 acquires the captured images imaged by the imaging device (image processing device 10) and recorded in the memory 1006. The captured image acquisition unit 401 then outputs the acquired captured image to the defocus range estimation unit 402. Here, as an example, we will assume that one (1 piece of) captured image is acquired and proceed with the processing. However, the number of captured images to be acquired is not limited to one, and there are no restrictions on the number of captured images to be acquired, such as acquiring multiple captured images to proceed with processing, and the present embodiment is not limited to the examples described below.

In S502, the defocus range estimation unit 402 inputs the captured images received from the captured image acquisition unit 401 into the defocus range estimation model recorded in the ROM 1004. Then, the captured image defocus range information is estimated, which indicates the defocus range of the entire subject, including each area of the person's body, such as the pupils, face, and torso, of the subject in the captured image. The defocus range estimation unit 402 then acquires the estimated result, the captured image defocus range information (first range information), and outputs the acquired captured image defocus range information to the incidental information storage unit 403.

The defocus range estimation model is a model acquired by machine learning. A specific algorithm for machine learning is deep learning, which uses a neural network to generate its own features and joint weighting coefficients for learning. Here, learning using a neural network will be described. Input data is learned using learning data including learning images and correct defocus range. The learning involves error detection processing and weight update processing. In the error detection processing, an error is obtained between the training data and the output data output from the output layer of the neural network in response to the input data input to the input layer. In this case, the correct defocus range is used for the training data. In the error detection processing, a loss function may be used to calculate the error between the output data from the neural network and the training data. In the weight updating processing, based on the error obtained in the error detection processing, the coupling weighting coefficients, or the like between the nodes of the neural network are updated so that the error is reduced.

In this weight updating processing, the coupling weighting coefficients, or the like is updated using, for example, the error back propagation method. The error back propagation method is a method to adjust the coupling weighting coefficients, or the like between the nodes of each neural network so that the above error is reduced.

The machine learning model trained by the learning method described above can be used to estimate the defocus range. As an example, it is described here that the defocus range is estimated using a defocus range estimation model learned with the input data as the learning image and the correct defocus range, but this is not limited to this case in the present embodiment. A machine learning model learned by different input data or a program that calculates the defocus range according to a predefined algorithm may be used.

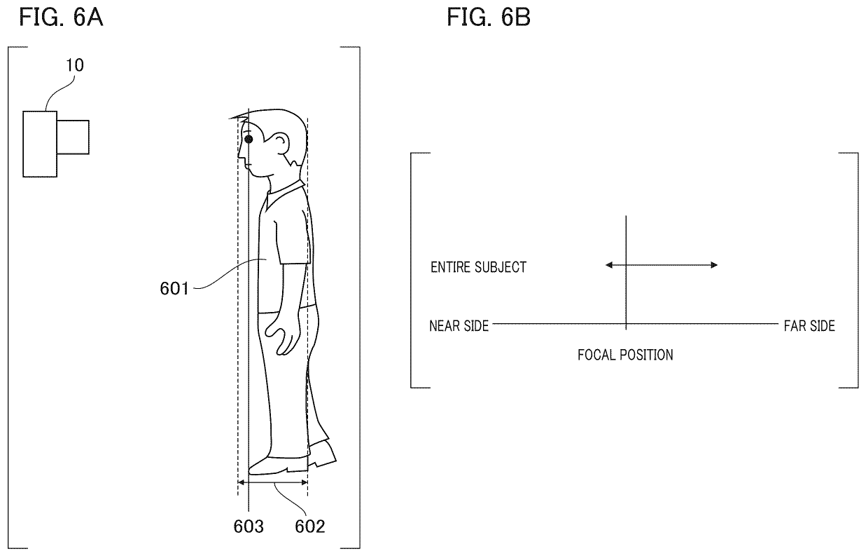

FIG. 6 illustrates an example of a result of estimating the defocus range of the entire subject in a captured image, estimated using the defocus range estimation model. Hereinafter, the estimation of the defocus range of the entire subject in a captured image and the result will be described with reference to FIG. 6. FIG. 6A illustrates a state where a subject 601 is imaged using the image processing device 10. FIG. 6B illustrates an example of the result of estimating the defocus range of the entire subject.

Reference numeral 602 in FIG. 6A indicates a visualization of the extent of the entire subject as an object in the depth direction as viewed from the image processing device 10. Further, reference numeral 603 represents a display of the focal position in the image processing device 10. The example illustrated in FIG. 6B estimates the defocus range, which is the value range of the defocus amount for the tip of the subject's nose, which is the most proximal, and the tip of the subject's shoulder, which is the most distant. Here, as an example, the entire subject has been described as a defocus range that estimates the range of defocus amounts from the nose tip of the subject to the shoulder tip of the subject, but the present embodiment is not limited to this case. For example, the entire subject may be defined as a range that includes the defocus amount of any area.

In S503, the incidental information storage unit 403 stores the captured image defocus range information received from the defocus range estimation unit 402 as incidental information for the captured image recorded in the memory 1006. The incidental information storage unit 403 then retrieves the captured image defocus range information stored as incidental information of the captured image and outputs it to the defocus range acquisition unit 404.

FIG. 7 illustrates a configuration example of a captured image in which captured image defocus range information is stored as incidental information. Hereinafter, with reference to FIG. 7, an example of the configuration of a captured image in which captured image defocus range information is stored as incidental information will be described.

Data 701 is data of a captured image recorded in the memory 1006 in a state in which captured image defocus range information is stored as incidental information of the captured image. Information 702 is the captured image defocus range information stored as incidental information and is configured of the defocus range estimation target, nearest defocus amount, and farthest defocus amount. As an example, the captured image defocus range information, consisting of the defocus range estimation target, nearest defocus amount, and farthest defocus amount, is stored in association with the captured image as incidental information. However, there are no restrictions on the composition of the captured image defocus range information to be stored as incidental information, and it is not limited to this case in the present embodiment. In a case where the defocus range is obtained for each area of the subject, the information on those parts and the information 702 are recorded in the memory 1006 as incidental information in the associated format.

In S504, the defocus range acquisition unit 404 receives the captured image defocus range information from the incidental information storage unit 403. The defocus range of the entire subject in the captured image is then acquired based on the defocus range estimation target, nearest defocus amount, and farthest defocus amount recorded in the captured image defocus range information. The defocus range acquisition unit 404 outputs the acquired defocus range of the entire subject to the depth-of-field calculation unit 405.

In S505, the depth-of-field calculation unit 405 calculates the depth-of-field of the captured image recorded in the memory 1006, which is associated with the defocus range received from the defocus range acquisition unit 404. The depth-of-field calculation unit 405 outputs the calculated depth-of-field and the defocus range received from the defocus range acquisition unit 404 to the focal ratio calculation unit 406.

In the processing of S505, the depth-of-field calculation unit 405 acquires the camera parameters at the time of imaging (focal length S, aperture value F, subject distance D, and allowable circle of confusion diameter δ) recorded in the incidental information of the captured image for the depth-of-field calculation. A depth-of-field X of the captured image is then calculated using Formula (1) below.

$$\begin{matrix}[ Formula 1 ] & \\ X = \frac{δ \times F \times {D}^{2}}{{F}^{2} + δ \times F \times D} + \frac{δ \times F \times {D}^{2}}{{F}^{2} - δ \times F \times D} & ( 1 )\end{matrix}$$

As an example, the depth-of-field was calculated using Formula (1) above. However, there are no restrictions on how depth-of-field is calculated, and the depth-of-field may be calculated by different means, such as using different formulas or estimation by machine learning models. In addition, for simplification of processing, the calculated depth-of-field value may be retained as incidental information in the image.

In S506, the focal ratio calculation unit 406 calculates the focal ratio according to the defocus range received from the depth-of-field calculation unit 405. Specifically, the focal ratio calculation unit 406 calculates the focal ratio, which indicates the ratio of the defocus range contained within the depth-of-field, based on the defocus range and the depth-of-field received from the depth-of-field calculation unit 405. In this processing, since the defocus range received is the defocus range of the entire subject in the captured image, the focal ratio calculation unit 406 calculates the focal ratio based on the defocus range of the entire subject in the captured image and the depth-of-field. The focal ratio calculation unit 406 then stores the calculated focal ratio in the memory 1006 as incidental information of the captured image associated with the defocus range received from the defocus range acquisition unit 404. That is, by performing the processing of S506, in addition to the above-mentioned information recorded in the memory 1006 associated with the defocus range received from the defocus range acquisition unit 404, information on the focal ratio is also stored as the incidental information.

In the description of the method of calculating the focal ratio in S506, the nearest defocus amount DN and the farthest defocus amount DF in the defocus range, and the nearest defocus amount XN and farthest defocus amount XF in the depth-of-field calculated from the depth-of-field X are used. In addition, in order to calculate the defocus amount as a positive number, when the minimum values of DN, DF, XN, and XF are modified so that each value is set to 0, dn, df, xn, and xf, respectively, the focal ratio Z (%) of the captured image is calculated using Formula (2) below.

$$\begin{matrix}[ Formula 2 ] & \\ Z = \{ \begin{matrix}0 ( xn ≧ df ) \\ 0 ( xf ≧ dn ) \\ \frac{( df - dn ) - ( xn - dn )}{df - dn} \times 100 ( xn > dn xf ≧ df ) \\ \frac{( df - dn ) - ( df - xf )}{df - dn} \times 100 ( xn ≦ dn xf < df ) \\ \frac{( df - dn ) - ( xn - dn ) - ( df - xf )}{df - dn} \times 100 ( xn > dn xf < df ) \\ 100 ( ≦ dn xf ≧ df )\end{matrix} & ( 2 )\end{matrix}$$

In this example, the focal ratio is calculated using Formula (2) above. However, there are no restrictions on the method of calculating the focal ratio of the captured image, and the focal ratio may be calculated by different means, such as by calculation using a different formula.

In S507, the captured image selection unit 407 acquires one or more captured images recorded in the memory 1006 and selects a captured image based on the focal ratio stored in the incidental information of the captured image. Specifically, the selection of the captured images to be displayed on the rear monitor 1009, or the like is performed based on the focal ratio stored in the incidental information of the acquired captured images and a predetermined threshold value set in advance. The captured image selection unit 407 then outputs the selected one or more captured images to the display order determination unit 408. The above predetermined threshold value indicates the threshold value used for selection that is set in advance in the RAM 1005, such as a focal ratio of 80% or higher, for example. In other words, when selecting the captured images to be displayed on the rear monitor 1009, or the like, the captured image selection unit 407 determines whether the focal ratio stored in the incidental information of each captured image is equal to or greater than a predetermined threshold value. A captured image that is equal to or greater than a predetermined threshold value is selected as the captured image to be displayed on the rear monitor 1009 or the like, and a captured image that is less than the predetermined threshold value is not selected as the captured image to be displayed on the rear monitor 1009 or the like.

In S508, the display order determination unit 408 acquires one or more selected captured images from the captured image selection unit 407 and determines the display order to be displayed on the rear monitor 1009, or the like based on the focal ratio stored in the incidental information of the captured images. Thereafter, one or more selected captured images received from the captured image selection unit 407 and the information on the display order determined as described above are output to the captured image display unit 409, which proceeds to S509.

When determining the display order in S508, specifically, the display order determination unit 408 sorts the images in descending order of the focal ratio, and creates a list indicating the order. As an example here, a method for determining the display order has been shown by sorting the images in order of highest focal ratio and creating a list, but there are no restrictions on the method for determining and storing the display order, such as sorting the images in order of lowest focal ratio and saving the display order in the additional information of the captured image rather than creating a list.

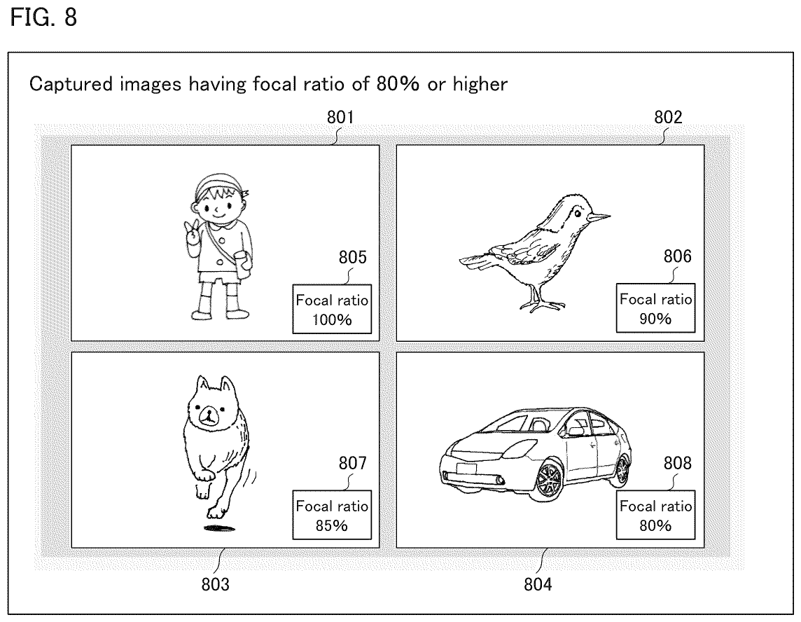

In S509, the captured image display unit 409 is associated with the captured image and the focal ratio based on one or more selected captured images and the display order information received from the display order determination unit 408, and displays them on the rear monitor 1009. Then, the processing ends. FIG. 8 is an example of a display in which the captured images and the focal ratios are associated based on the display order. Hereinafter, display of a captured image associated with a focal ratio will be described with reference to FIG. 8.

A captured image 801, a captured image 802, a captured image 803, and a captured image 804 are examples of captured images selected by the captured image selection unit 407. A focal ratio 805 is information stored as incidental information in the captured image 801. A focal ratio 806 is information stored as incidental information in the captured image 802. A focal ratio 807 is information stored as incidental information in the captured image 803. A focal ratio 808 is information stored as incidental information in the captured image 804.

The captured image display unit 409 displays these selected captured images on the rear monitor 1009, or the like in the order of the captured image 801 to the captured image 804 based on the display order information determined by the display order determination unit 408. In addition, the captured image display unit 409 also displays the focal ratio stored in the captured image as incidental information, which is associated with the captured image. In the case of FIG. 8, for example, when the captured image 801 is displayed, the focal ratio 805 is also displayed together with the captured image on the rear monitor 1009, or the like as illustrated in FIG. 8. In other words, the captured image display unit 409 superimposes information on the focal ratio 805 on the captured image 801 and displays it on the rear monitor 1009, or the like. However, here, as an example, an example is shown in which the captured images and the focal ratio are associated and displayed based on the display order, but there are no restrictions on display control such as the number of captured images to be displayed or the display position of the focal ratio, and the present embodiment is not limited to this case. In addition, the focal ratio to be displayed associated with the captured image may be displayed not as a numerical value showing a percentage, as in FIG. 8, but as a graph that shows, for example, the percentage of focal ratio.

Through the above processing, the focal ratio of the entire subject is calculated based on the defocus range information stored in the incidental information of the captured image, and the captured images can be displayed by selecting images and determining the display order.

Thus, according to the image processing device 10 of the present embodiment, the focal ratio is calculated based on the defocus range information for the entire subject stored as incidental information in the captured image. Then, captured images are selected and the display order are determined based on the calculated focal ratio, and the captured images are displayed in association with the focal ratio, thereby assisting the user (operator, worker) in selecting captured images.

In addition, in the present embodiment, the defocus range may be estimated from a live view image acquired during AF control, and the result may be used to perform AF control and acquire a captured image. The defocus range may then be estimated again with the captured image taken and saved after AF control, and the result may be stored in the incidental information of the captured image.

In the present embodiment, an imaging apparatus (imaging device) is shown as an example as the image processing device 10, but a general-purpose PC can also be used as an image processing device to calculate the focal ratio. In such a case, the focal ratio is calculated from the defocus range information and the information at the time of shooting (focal length S, aperture value F, subject distance D, and allowable circle of confusion diameter δ) as incidental information of the captured image, enabling the processing of S508 and S509 in FIG. 5. In addition, at this time, a captured image display unit 913 may display the image on an external monitor.

### Embodiment 2

An image processing device 90 of Embodiment 2 will be described below. In Embodiment 2, the defocus range is estimated with the live view image acquired during AF control, and based on the results of the estimation, the drive amount (lens drive amount) of the imaging lens 1101 during AF control is calculated. Next, the results are used to perform AF control and acquire the captured image. Next, the captured image, the estimation result, and the lens drive amount are stored in the incidental information of the captured image. This is because there is a time lag between the live view image and the captured image during AF control, and the estimated results of the defocus range may not match. The defocus range of the captured image is then calculated using the estimated defocus range of the stored live view image and the lens drive amount. Furthermore, the defocus range of each area of the subject is obtained from the captured image defocus range information, and the focal ratio for each area is calculated. Then, based on the calculated focal ratio and the focal ratio corresponding to the selected area input by the user, the captured image is selected and the partial area image is displayed in association with the focal ratio. By carrying out such processing, it is possible to assist the user in selecting the captured images.

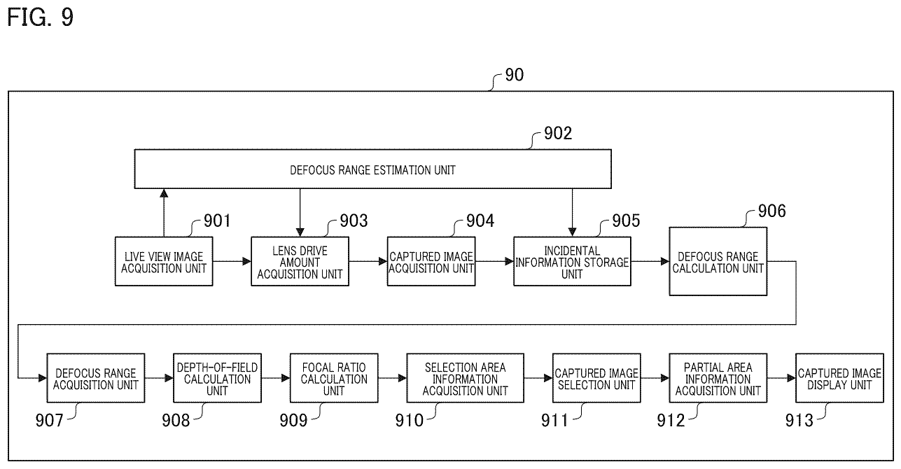

FIG. 9 is a block diagram illustrating a configuration example of the image processing device 90 according to Embodiment 2. The image processing device 90 includes a live view image acquisition unit 901, a defocus range estimation unit 902, a lens drive amount acquisition unit 903, a captured image acquisition unit 904, an incidental information storage unit 905, and a defocus range calculation unit 906. Furthermore, the image processing device 90 includes a defocus range acquisition unit 907, a depth-of-field calculation unit 908, a focal ratio calculation unit 909, a selection area information acquisition unit 910, a captured image selection unit 911, a partial area information acquisition unit 912, and the captured image display unit 913.

The configuration of the image processing device 90 according to Embodiment 2 is substantially the same as the configuration of the image processing device 10 according to Embodiment 1 illustrated in FIG. 4. For this reason, descriptions of the same functional parts are omitted, and functional parts with differences are explained. Specifically, the live view image acquisition unit 901, the defocus range estimation unit 902, the lens drive amount acquisition unit 903, the incidental information storage unit 905, and the defocus range calculation unit 906 are described below. In addition, the selection area information acquisition unit 910, the captured image selection unit 911, the partial area information acquisition unit 912, and the captured image display unit 913 are also described below.

The live view image acquisition unit 901 acquires live view images temporarily recorded in the RAM 1005 for use during autofocus control (AF control). The live view image acquisition unit 901 then outputs the acquired live view image to the defocus range estimation unit 902 and the lens drive amount acquisition unit 903.

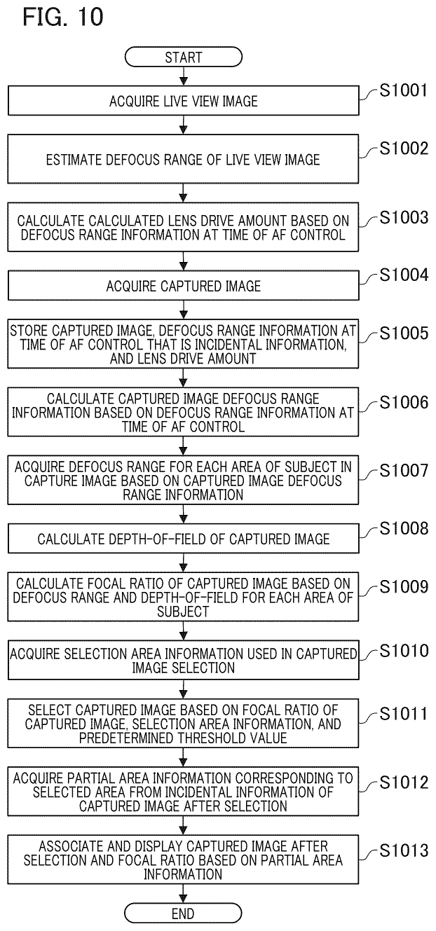

The defocus range estimation unit (AF control defocus range estimation unit) 902 estimates the defocus range for each area of the subject in the received live view image. The details of the defocus range estimation during AF control by the defocus range estimation unit 902 will be described using the flowchart in FIG. 10 below. The defocus range estimation unit 902 acquires the estimated result, the defocus range information at the time of AF control (second range information), and outputs the defocus range information at the time of AF control to the lens drive amount acquisition unit 903 and the incidental information storage unit 905.

The lens drive amount acquisition unit 903 acquires the lens drive amount to be used for AF control by executing the drive amount calculation of the imaging lens 1101 in the lens control unit 1105 based on the received live view image and the defocus range information at the time of AF control. The lens drive amount acquisition unit 903 then outputs the acquired lens drive amount to the captured image acquisition unit 904.

The incidental information storage unit 905 controls AF based on the received lens drive amount and acquires the captured images. In addition, it also receives the defocus range information at the time of AF control output from the defocus range estimation unit 902. Then, the lens drive amount and the defocus range information at the time of AF control received in the incidental information of the acquired captured image are stored and recorded in the memory 1006. The details of the processing of storing the incidental information as incidental information on the captured image by the incidental information storage unit 905 will be described using the flowchart in FIG. 10 below. The incidental information storage unit 905 outputs the defocus range information at the time of AF control and the lens drive amount to the defocus range calculation unit 906.

The defocus range calculation unit 906 reflects the amount of change in the defocus range based on the received defocus range information at the time of AF control and the lens drive amount, and calculates the captured image defocus range information (first range information), which is the result of the captured image defocus range estimation. The details of the calculation of the captured image defocus range will be described in the flowchart in FIG. 10 below. The defocus range calculation unit 906 outputs the calculated captured image defocus range information to the defocus range acquisition unit 907.

The selection area information acquisition unit 910 acquires information on the selected subject area (selection area information) from the touch panel 1010 or other input device. Thereafter, the selection area information acquisition unit 910 outputs the acquired selected area information to the captured image selection unit 911.

The captured image selection unit 911 acquires one or more captured images recorded in the memory 1006 and selects captured images in which the numerical value of the focal ratio of a specific area is equal to or greater than a predetermined threshold value based on the focal ratio and the selected area information stored in the incidental information of the captured images. The captured image selection unit 911 outputs one or more captured images and selected area information after selection to the partial area information acquisition unit 912.

The partial area information acquisition unit 912 acquires partial area information indicating the area in the captured image of a specific area based on the area information of each area detected at the time of capture and the selected area information stored in the incidental information of one or more captured images after selection received from the captured image selection unit 911. The partial area information acquisition unit 912 then outputs one or more captured images after selection and the acquired partial area information to the captured image display unit 913.

The captured image display unit 913 associates the captured image with the focal ratio based on the received one or more selected captured images and partial area information, and displays them on the rear monitor 1009. When displaying the captured image on the rear monitor 1009, the captured image display unit 913 displays the image on the rear monitor 1009 associating with the focal ratio. In addition, the captured image display unit 913 may display the captured image and the focal ratio on a display device such as an external monitor or display, similarly to Embodiment 1. The display device may be configured integrally with a client device (information processing device) such as a PC, or may be configured separately. In addition, the captured image display unit 913 may display the captured image on a plurality of display means such as the external device and the rear monitor 1009.

Next, a processing procedure performed by the image processing device 90 in the present embodiment will be described with reference to FIG. 10. In the following description, each process (step) is denoted by an S at the beginning. FIG. 10 is a flowchart illustrating the processing of the image processing device 10 according to Embodiment 2. Specifically, the flowchart illustrates the processing procedure in which the image processing device 90 calculates the focal ratio for each area of the subject based on the defocus range information at the time of AF control stored in the incidental information of the captured image, and displays image selection and partial area images based on the input selection area information.

Each operation (processing) illustrated in the flowchart of FIG. 10 is realized by the system control unit 1002 executing a program stored in the ROM 1004 or the like. In addition, in the following description, each process (step) is indicated by adding S at the beginning of the process (step) and the notation of the process (step) will be omitted. In order to clarify the difference in processing from that described in FIG. 5 in Embodiment 1, the same processing described in FIG. 5 is omitted. Specifically, S1004 and S1008 in FIG. 10 are similar to S501 and S505 illustrated in FIG. 5 of Embodiment 1, so the description thereof will be omitted.

In S1001, the live view image acquisition unit 901 acquires the live view image temporarily recorded in the RAM 1005 for use during AF control. The captured image acquisition unit 904 then outputs the acquired live view image to the defocus range estimation unit 902 and the lens drive amount acquisition unit 903. Here, as an example, we will assume that one (1 piece of) live view image is acquired and proceed with the processing. However, the number of live view images to be acquired is not limited to one, and there are no restrictions on the number of captured images to be acquired, such as acquiring multiple live view images and the present embodiment is not limited proceeding with processing, and the examples described below.

In S1002, the defocus range estimation unit 902 inputs the live view image received from the live view image acquisition unit 901 into the defocus range estimation model recorded in the ROM 1004. Then, the defocus range information at the time of AF control indicating the defocus range of each area of the human body, such as the pupil, face, and torso of the subject in the live view image, is estimated. The defocus range estimation unit 902 then acquires the estimated result, defocus range information at the time of AF control (first range information), and outputs it to the acquired lens drive amount acquisition unit 903 and the incidental information storage unit 905.

The defocus range estimation model is the same as the machine learning model described in S502, so a detailed explanation will be omitted. As an example here, the defocus range is estimated using a defocus range estimation model learned with the input data as the training image and the correct defocus range, but this is not limited to this case in the present embodiment. A machine learning model learned by different input data or a program that calculates the defocus range according to a predefined algorithm may be used.

In S1003, the lens drive amount acquisition unit 903 calculates the lens drive amount based on the live view image received from the live view image acquisition unit 901 and the defocus range information at the time of AF control received from the defocus range estimation unit 902. This obtains the lens drive amount to be used by the lens control unit 1105 at the time of AF control. The lens drive amount acquisition unit 903 then outputs the acquired lens drive amount to the captured image acquisition unit 904.

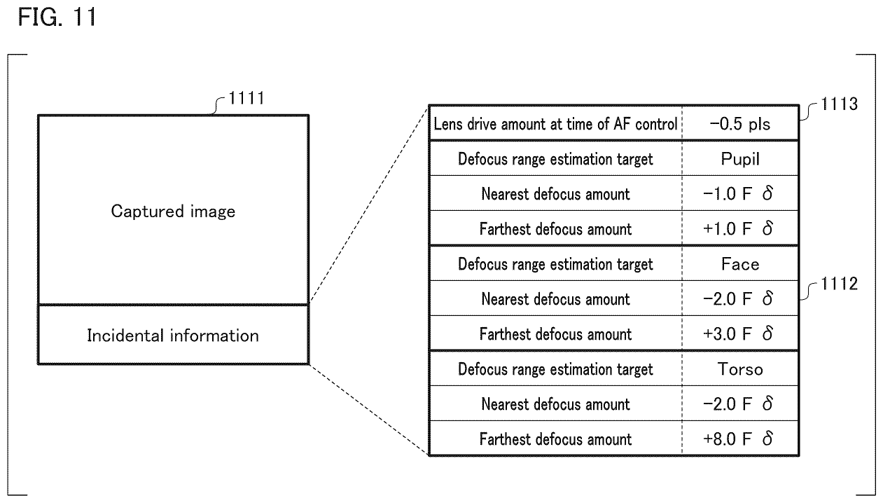

In S1005, the incidental information storage unit 905 acquires the captured images by AF controlling based on the lens drive amount received from the captured image acquisition unit 904. The incidental information storage unit 905 receives the defocus range information at the time of AF control from the defocus range estimation unit 902. The lens drive amount and the defocus range information at the time of AF control received in the incidental information of the captured image are then stored and recorded in the memory 1006. The incidental information storage unit 905 then outputs the defocus range information at the time of AF control and the lens drive amount to the defocus range calculation unit 906. FIG. 11 illustrates a configuration example of a captured image in which defocus range information at the time of AF control is stored as incidental information. Hereinafter, a captured image in which defocus range information at the time of AF control is stored as incidental information will be described with reference to FIG. 11.

Reference numeral 1111 in FIG. 11 denotes a captured image recorded in the memory 1006, to which defocus range information at the time of AF control is stored as incidental information. Reference numeral 1112 denotes defocus range information at the time of AF control stored as incidental information. The defocus range information at the time of AF control is configured of the defocus range estimation target, the nearest defocus amount, and the farthest defocus amount. Reference numeral 1113 denotes the lens driving amount used for AF control when capturing a captured image.

As an example, the defocus range information at the time of AF control, which consists of the defocus range estimation target, the nearest defocus amount, the farthest defocus amount, and the lens drive amount at the time of AF control, is stored as incidental information. However, the present invention is not limited to this example, and there is no restriction on the configuration of the defocus range information at the time of AF control stored as the incidental information, and the present embodiment is not limited to this case.

In S1006, the defocus range calculation unit 906 calculates the captured image defocus range information, which is the result of the captured image defocus range estimation. Specifically, the captured image defocus range information is calculated by reflecting the amount of change in the defocus range based on the defocus range information at the time of AF control received by the defocus range calculation unit 906 and the lens drive amount. The defocus range calculation unit 906 outputs the calculated captured image defocus range information to the defocus range acquisition unit 907.

In order to calculate the captured image defocus range information, a lens drive coefficient B, an aperture value F, an allowable circle of confusion diameter 8 and a lens drive amount L at the time of imaging, which are recorded in the incidental information of the captured image, are acquired. Then, the change amount C of the defocus range is calculated by Formula (3) below, and the change amount C is used to calculate the captured image defocus range information.

$$\begin{matrix}[ Formula 3 ] & \\ C = \frac{L \times B}{F \times δ} & ( 3 )\end{matrix}$$

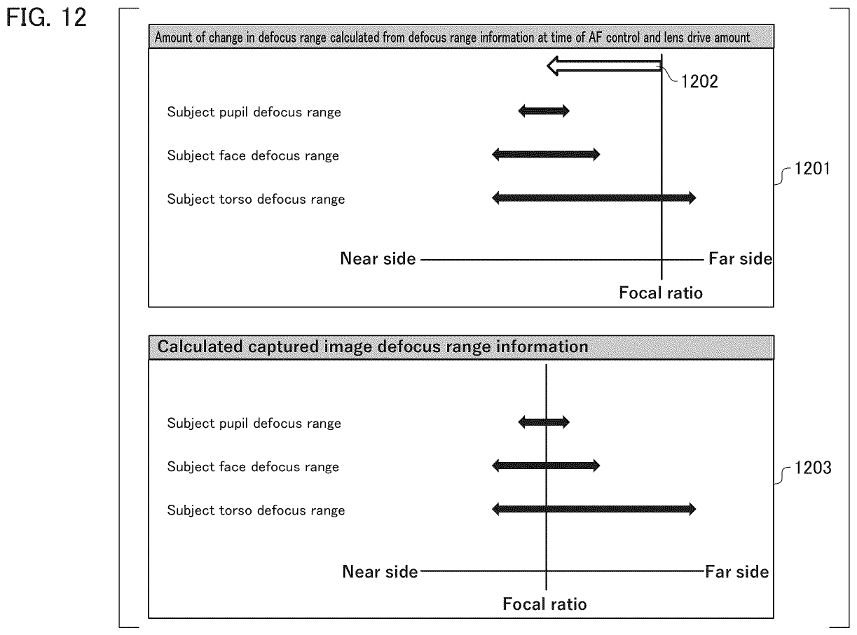

As an example, Formula (3) above was used to calculate the amount of change in the defocus range. However, there are no restrictions on the method of calculating the amount of change in the defocus range, and the amount of change in the defocus range may be calculated by different means, such as by calculation using a different formula. FIG. 12 illustrates a method of calculating captured image defocus range information. The method of calculating the captured image defocus range information will be described below with reference to FIG. 12.

Reference numeral 1201 denotes defocus range information at the time of AF control. Reference numeral 1202 denotes the amount of change in the defocus range calculated from the lens drive amount. Reference numeral 1203 denotes the calculated captured image defocus range information. As an example, the captured image defocus range information at the time of AF control, including the defocus range of each area of the subject's pupil, face, and torso, is calculated based on the amount of change in the defocus range calculated from the lens drive amount. However, there are no restrictions on the configuration or calculation method of the defocus range information, and it is not limited to this case in the present embodiment.

In S1007, the defocus range acquisition unit 907 receives the captured image defocus range information from the defocus range calculation unit 906. The defocus range of each area of the subject in the captured image is then obtained based on the defocus range estimation target, nearest defocus amount, and farthest defocus amount recorded in the captured image defocus range information. The defocus range acquisition unit 907 outputs the acquired defocus range for each area of the subject to the depth-of-field calculation unit 908.

In S1009, the focal ratio calculation unit 909 calculates the focal ratio according to the defocus range received from the depth-of-field calculation unit 908. Specifically, the focal ratio calculation unit 909 calculates the focal ratio, which indicates the ratio of the defocus range contained within the depth-of-field for each area of the subject, based on the defocus range and depth-of-field for each area of the subject received from the depth-of-field calculation unit 908. The focal ratio calculation unit 909 stores the calculated focal ratio for each area in the incidental information of the captured image recorded in the memory 1006 that is associated with the defocus range received from the defocus range acquisition unit 907. In S1009, the focal ratio of each area is calculated. However, the method of calculating the focal ratio is the same as that described in S506, so a detailed description will be omitted.

In S1010, the selection area information acquisition unit 910 acquires selection area information, which is information on the subject's pupils, face, torso, and other parts of the subject used in image selection, from the touch panel 1010 or other input device and outputs it to the captured image selection unit 911. However, as an example here, an example has been shown in which selected area information such as the subject's eyes, face, and torso is obtained from an input device such as a touch panel, but there are no restrictions on the input method of the selected area information or the configuration of the selected area information, and the present embodiment is not limited to this case.

In S1011, the captured image selection unit 911 acquires one or more captured images recorded in the memory 1006. Then, a captured image in which the focal ratio value of a specific area is equal to or greater than a predetermined threshold value set in advance is selected based on the focal ratio stored in the incidental information of the captured image and the selected area information received from the selection area information acquisition unit 910. One or more captured images after selection and the selected area information are output to the partial area information acquisition unit 912. The above predetermined threshold value indicates the threshold value used for selection, which is preset in the RAM 1005, such as 80% or more focal ratio. The above and other threshold values are pre-set in the RAM 1005 to be used for selection.

In S1012, the partial area information acquisition unit 912 acquires partial area information based on the area information and selected area information for each area of the subject detected at the time of imaging that is stored in the incidental information of one or more post-selection captured images received from the captured image selection unit 911. The partial area information is information that indicates the area in the captured image of a specific area. The partial area information acquisition unit 912 then outputs the one or more captured images after selection and the acquired partial area information to the captured image display unit 913.

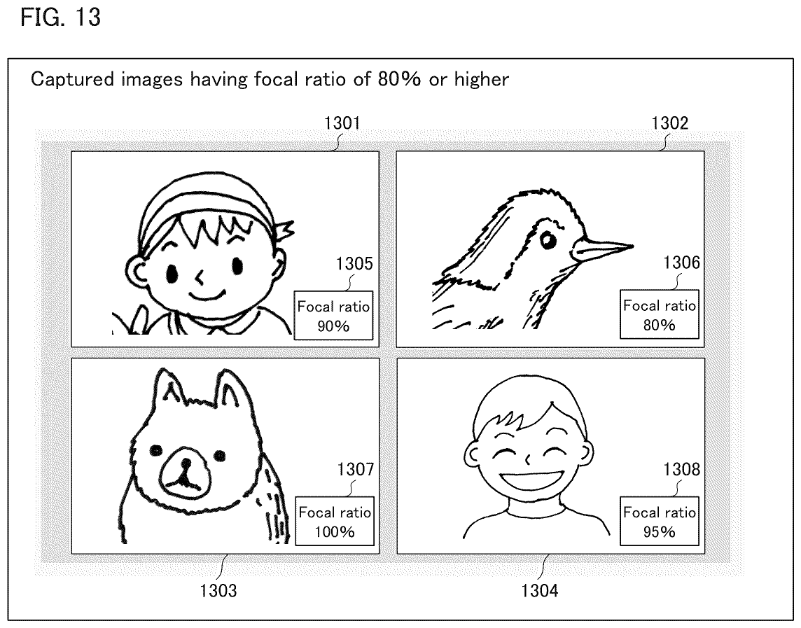

In S1013, the captured image display unit 913 associates the captured image and the focal ratio based on one or more captured images after selection and the partial area information received from the partial area information acquisition unit 912, and displays them on the rear monitor 1009, or the like. Then, the processing ends. FIG. 13 is an example of a display in which a captured image is associated with a focal ratio based on partial area information. Hereinafter, a display in which the captured image and the focal ratio are associated with each other based on the partial area information will be described with reference to FIG. 13.

A captured image 1301, a captured image 1302, a captured image 1303, and a captured image 1304 are examples of captured images showing an enlarged partial area of a face in the captured image selected based on the focal ratio of the face after the face was input at the selection area information acquisition unit 910. A focal ratio 1305 is information stored as incidental information in the captured image 1301. A focal ratio 1306 is information stored as incidental information in the captured image 1302. A focal ratio 1307 is information stored as incidental information in the captured image 1303. A focal ratio 1308 is information stored as incidental information in the captured image 1304.

The captured image display unit 913 also displays the focal ratio stored in the captured image as incidental information, which is associated with the captured image. In the case of FIG. 13, for example, when the captured image 1301 is displayed, the focal ratio 1305 is also displayed on the rear monitor 1009, or the like together with the captured image, as illustrated in FIG. 11. In other words, the captured image display unit 913 superimposes the information on the focal ratio 1305 on the captured image 1301 and displays the information. Although the example shown here is an example in which the captured image and focus rate are associated with each other and displayed based on partial area information, there are no restrictions on the number of captured images to be displayed, the display position of the focal ratio, or other display controls, and the present embodiment is not limited to this case.

As described above, according to the image processing device 90 of the present embodiment, the focal ratio of each area of the subject is calculated based on the defocus range information at the time of AF control stored in the incidental information of the captured image. Then, by selecting images and displaying partial area images based on the selected area information input by the user, it is possible to assist the user (operator, worker) in selecting captured images, as in Embodiment 1.

The above described embodiments are only representative examples, and various variations and changes to the above embodiments are possible when implementing the invention.

For example, in Embodiment 1 and Embodiment 2, the description was given as an image processing device that stores defocus range information in the incidental information of captured images in a single image processing device, obtains the defocus range from the defocus range information in the stored incidental information, and calculates the focal ratio. However, this is not the only case. For example, a captured image with its incidental information stored therein is recorded in a removable flash memory, and the flash memory is read by a separate image processing device. The defocus range may then be acquired from the defocus range information stored in the incidental information of the captured image in the separate image processing device, and the focal ratio may be calculated.

The processing in FIG. 5 performed by the image processing device 10 and the processing in FIG. 10 performed by the image processing device 90 are examples, and the image processing device in the present embodiment may change the processing or processing details depending on the user settings or the situation before the start of processing. In other words, the image processing device does not necessarily have to perform all the processes (steps) described in the flowcharts shown in FIGS. 5 and 10.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-78896, filed May 14 2024, which is hereby incorporated by reference wherein in its entirety.

What is claimed is:

1. An image processing device comprising:
calculation means for acquiring information including a defocus range of a captured image from storage means in which information including the defocus range of the captured image is stored as incidental information of the captured image, and calculating a focal ratio of the captured image based on the information including the defocus range; and
display control means for performing display control of the captured image based on the focal ratio.

2. The image processing device according to claim 1, wherein
the defocus range of the captured image is a defocus range of an entire subject in the captured image, which is estimated using a defocus range estimation model.

3. The image processing device according to claim 1, wherein
the calculation means calculates the focal ratio according to the defocus range of the entire subject in the captured image.

4. The image processing device according to claim 1, wherein
the calculation means calculates the focal ratio based on the defocus range and a depth-of-field of the captured image.

5. The image processing device according to claim 1, wherein
the display control means displays the focal ratio on display means in association with the captured image.

6. The image processing device according to claim 1, the image processing device further comprising:
display order determination means for determining the display order of the captured images based on the focal ratio, wherein
the display control means displays the captured images on the display means based on the determined display order.

7. The image processing device according to claim 1, the image processing device further comprising:
selection means for selecting the captured images to be displayed on the display means based on the focal ratio.

8. The image processing device according to claim 1, the image processing device further comprising:
selection means for selecting the captured images to be displayed on the display means based on the focal ratio and a predetermined threshold value.

9. The image processing device according to claim 1, wherein
the defocus range of the captured image is estimated from the defocus range estimated from a live view image and a lens drive amount for AF control.

10. The image processing device according to claim 1, wherein
the defocus range of the captured image is estimated for each area of the subject.

11. The image processing device according to claim 9, wherein
the storage means stores the defocus range estimated from the live view image and the lens drive amount as incidental information of the captured image, as information including the defocus range of the captured image.

12. The image processing device according to claim 1, the image processing device further comprising:
selection means for selecting the captured images to be displayed on the display means based on the focal ratio corresponding to the area of the subject selected from an input device.

13. An image processing method comprising:
acquiring information including a defocus range of a captured image from storage means in which information including the defocus range of the captured image is stored as incidental information of the captured image, and calculating a focal ratio of the captured image based on the information including the defocus range; and
performing display control of the captured image based on the calculated focal ratio.

14. A non-transitory computer-readable storage medium configured to store a computer program comprising instructions for executing following processes:
acquiring information including a defocus range of a captured image from storage means in which information including the defocus range of the captured image is stored as incidental information of the captured image, and calculating a focal ratio of the captured image based on the information including the defocus range; and
performing display control of the captured image based on the focal ratio.

15. An image processing device comprising:
acquisition means for estimating a defocus range of a captured image and acquiring the estimated result as defocus range information; and
focal ratio calculation means for calculating a focal ratio of the captured image based on the defocus range information acquired by the acquisition means.

16. An image processing method comprising:
estimating a defocus range of a captured image and acquiring the estimated result as defocus range information; and
calculating a focal ratio of the captured image based on the defocus range information acquired in the acquisition process.
